(19) United States
(12) Patent Application Publication
(10) Pub. No.: US 2026/0371039 A1
(43) Pub. Date: Nov. 19, 2026

(54) INFORMATION PROCESSING METHOD AND APPARATUS, AND COMMUNICATION DEVICE AND STORAGE MEDIUM

(71) Applicant: Beijing Xiaomi Mobile Software Co., Ltd., Beijing (CN)

(72) Inventor: Jianning LIU, Beijing (CN)

(21) Appl. No.: 19/102,129

(22) PCT Filed: Aug. 9, 2022
(86) PCT No.: PCT/CN2022/111288

§ 371 Date: Feb. 7, 2025

(51) Int. Cl. H04W 4/20; H04W 84/18

(52) U.S. Cl. CPC H04W 4/20; H04W 84/18

(57) ABSTRACT

An information processing method is performed by a first network device, and includes: transmitting a deleting notification for a Personal Internet of Things Network (PIN) to a second network device, wherein the deleting notification is configured to notify deletion of the PIN.

### CROSS REFERENCE TO RELATED APPLICATIONS

This application is a US National Phase of a PCT Application No. PCT/CN 2022/111288 filed on Aug. 9, 2022, the entire content of which is incorporated herein by reference.

### TECHNICAL FIELD

The present disclosure relates to the field of wireless communication technology, but is not limited to the field of wireless communication technology, and particularly relates to information processing methods and apparatuses, communication devices, and storage media.

### BACKGROUND

The Personal Internet of Things Network (PIN) consists of Personal Internet of Things Network Elements (PINEs) that communicate using PIN Direct Connection or direct network connection and are managed locally (using a PIN element with management capability).

Examples of PINEs can include networks of wearable devices and smart home/smart office devices.

According to the capabilities possessed by PINEs, PINEs can include PIN Elements with Gateway Capability (PEGCs), PIN Elements with Management Capability (PEMCs), and regular PINEs. Regular PINEs do not have the gateway capabilities or management capabilities of PINs.

### SUMMARY

The first aspect of the embodiments of the present disclosure provides an information processing method, where the method is performed by a first network device and includes: transmitting a deleting notification for a Personal Internet of Things Network (PIN) to a second network device, where the deleting notification is configured to notify deletion of the PIN.

The second aspect of the embodiments of the present disclosure provides an information processing method, where the method is performed by a second network device and includes: receiving a deleting notification for a Personal Internet of Things Network (PIN) transmitted by a first network device; and
transmitting the deleting notification to a PIN Element with Management Capability (PEMC) or a PIN Element with Gateway Capability (PEGC), where the deleting notification is configured to notify deletion of the PIN.

The third aspect of the embodiments of the present disclosure provides an information processing method, where the method is performed by PEMC or PEGC, and the method includes:
receiving a deleting notification for a Personal Internet of Things Network (PIN) transmitted by a second network device; and
transmitting the deleting notification to a PIN Element (PINE) of the PIN, where the deleting notification is configured to notify deletion of the PIN.

The fourth aspect of the embodiments of the present disclosure provides an information processing method, where the method is performed by a PIN and includes:
receiving the deleting notification transmitted by PEMC or PEGC; where the deleting notification is configured to notify the deletion of the PIN.

The fifth aspect of the embodiments of the present disclosure provides an information processing apparatus, where the apparatus includes:
a first transmitting module, configured to transmit a deleting notification for a Personal Internet of Things Network (PIN) to a second network device when the PIN needs to be deleted, where the deleting notification is configured to notify deletion of the PIN.

The sixth aspect of the embodiments of the present disclosure provides an information processing apparatus, where the apparatus includes:
a third receiving module, configured to receive a deleting notification for a Personal Internet of Things Network (PIN) transmitted by a first network device; and a third transmitting module, configured to transmit the deleting notification to a PIN Element with Management Capability (PEMC) or a PIN Element with Gateway Capability (PEGC), where the deleting notification is configured to notify deletion of the PIN.

The seventh aspect of the embodiments of the present disclosure provides an information processing apparatus, where the apparatus includes:
a fourth receiving module, configured to receive a deleting notification for a Personal Internet of Things Network (PIN) transmitted by a second network device; and a fourth transmitting module, configured to transmit the deleting notification to a PIN Element (PINE) of the PIN, where the deleting notification is configured to notify deletion of the PIN.

The eighth aspect of the embodiments of the present disclosure provides an information processing apparatus, where the apparatus includes:
a fifth receiving module, configured to receive a deleting notification transmitted by a PIN Element with Management Capability (PEMC) or a PIN Element with Gateway Capability (PEGC); where the deleting notification is configured to notify deletion of the PIN.

According to a ninth aspect of the embodiments of the present disclosure, a communication device is provided, the communication device includes a processor, a transceiver, a memory and an executable program stored in the memory and capable of being executed by the processor, where when the processor executes the executable program, the method according to any one of the first to fourth aspects is implemented.

According to a tenth aspect of the embodiments of the present disclosure, a computer storage medium is provided, the computer storage medium stores an executable program when executed by a processor, to implement the method according to any one of the first to fourth aspects.

The eleventh aspect of the embodiments of the present disclosure provides a communication system including a first network device, a second network device, a third network device, and a PIN Element (PINE);

The first network device is configured to transmit a deleting notification for a Personal Internet of Things Network (PIN) to the second network device, where the deleting notification is configured to request deletion of the PIN; and The second network device is configured to receive the deleting notification for the PIN transmitted by the first network device and transmit the deleting notification to the PINE through the third network device; where the third network device is a PIN Element with Management Capability (PEMC) or a PIN Element with Gateway Capability (PEGC).

The technical solution provided in the embodiments of the present disclosure, in which the first network device determines that the PIN needs to be deleted, and transmits a deleting notification for the PIN to the second network device, which can facilitate the deletion of PIN and standardize the deletion process.

It is to be understood that the above general descriptions and the below detailed descriptions are merely exemplary and explanatory, and are not intended to limit the present disclosure.

The accompanying drawings are incorporated in and constitute a part of the present description, illustrate embodiments consistent with the present disclosure and serve to explain the principles of the embodiments in present disclosure together with the description.

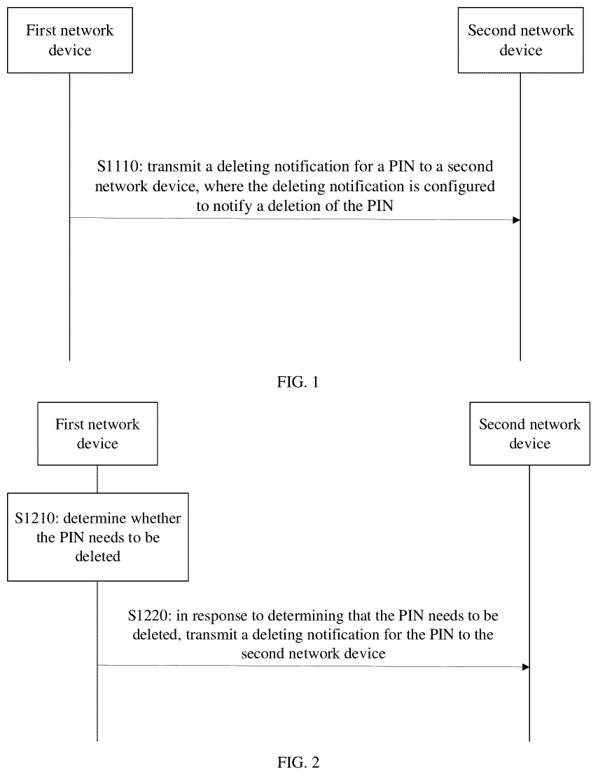

FIG. 1 is a flowchart of an information processing method according to an embodiment.

FIG. 2 is a flowchart of an information processing method according to an embodiment.

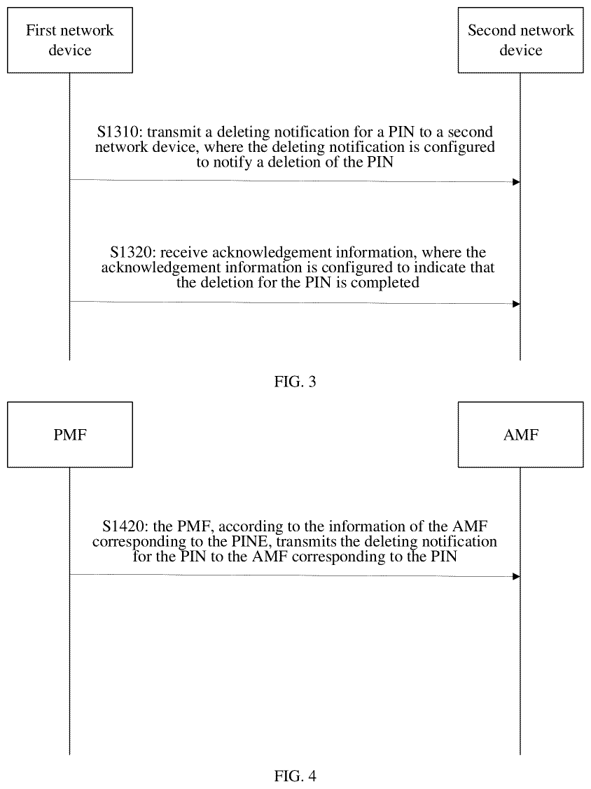

FIG. 3 is a flowchart of an information processing method according to an embodiment.

FIG. 4 is a flowchart of an information processing method according to an embodiment.

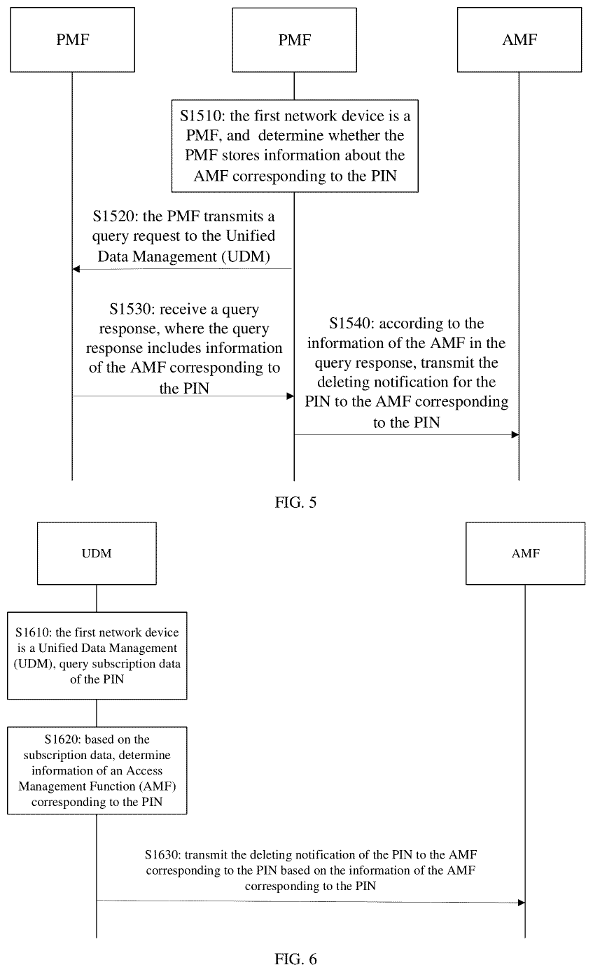

FIG. 5 is a flowchart of an information processing method according to an embodiment.

FIG. 6 is a flowchart of an information processing method according to an embodiment.

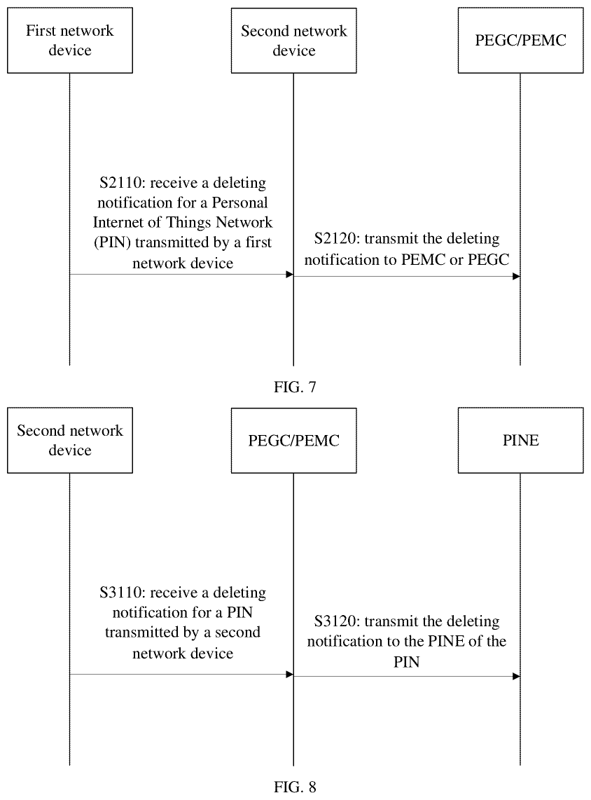

FIG. 7 is a flowchart of an information processing method according to an embodiment.

FIG. 8 is a flowchart of an information processing method according to an embodiment.

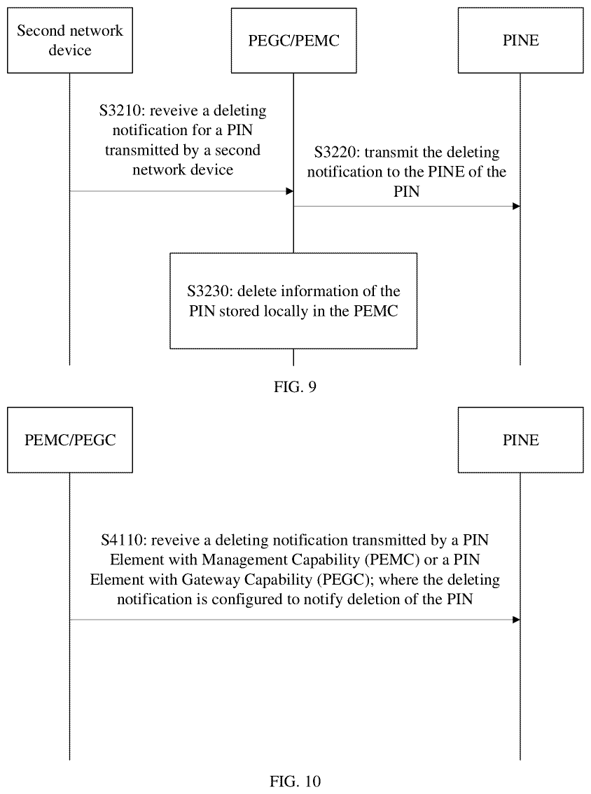

FIG. 9 is a flowchart of an information processing method according to an embodiment.

FIG. 10 is a flowchart of an information processing method according to an embodiment.

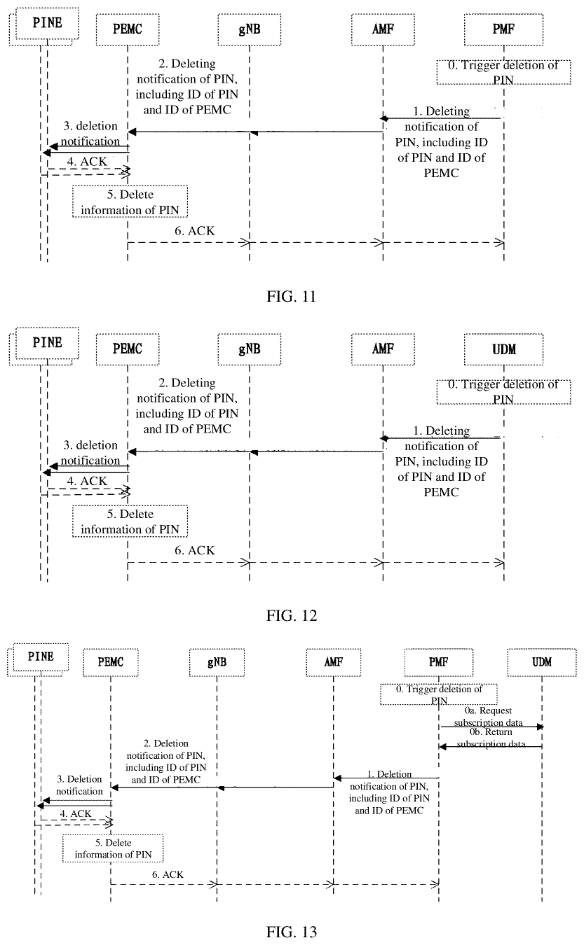

FIG. 11 is a flowchart of an information processing method according to an embodiment.

FIG. 12 is a flowchart of an information processing method according to an embodiment.

FIG. 13 is a flowchart of an information processing method according to an embodiment.

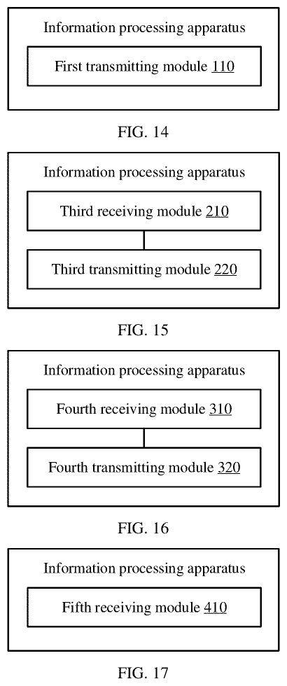

FIG. 14 is a schematic structural diagram of an information processing apparatus according to an embodiment.

FIG. 15 is a schematic structural diagram of an information processing apparatus according to an embodiment.

FIG. 16 is a schematic structural diagram of an information processing apparatus according to an embodiment.

FIG. 17 is a schematic structural diagram of an information processing apparatus according to an embodiment.

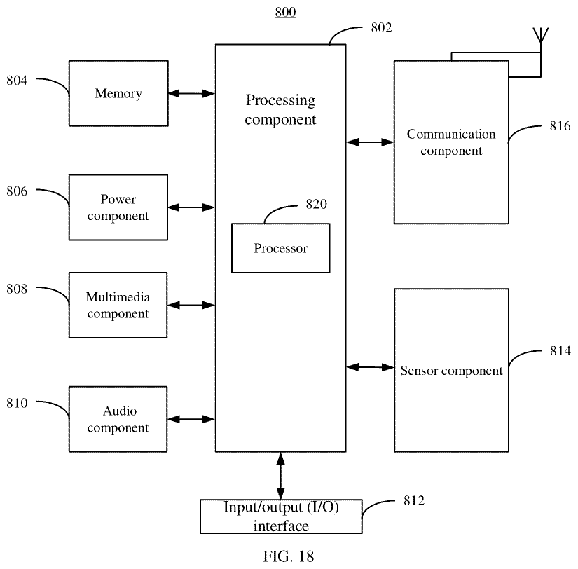

FIG. 18 is a schematic structural diagram of a communication device according to an embodiment.

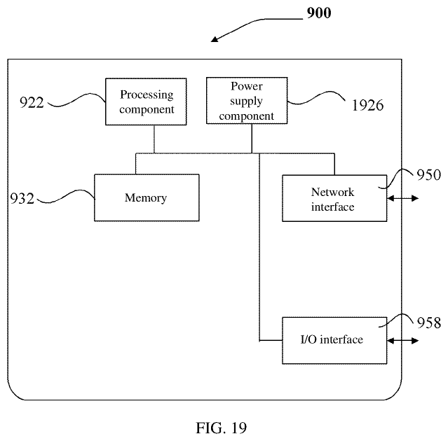

FIG. 19 is a schematic structural diagram of a network device according to an embodiment.

### DETAILED DESCRIPTION

Embodiments will be described in detail herein, examples of which are illustrated in the accompanying drawings. Where the following description refers to the drawings, elements with the same numerals in different drawings refer to the same or similar elements unless otherwise indicated. Implementations described in the following embodiments do not represent all implementations consistent with the present disclosure. Rather, they are merely embodiments of apparatuses and methods consistent with some aspects of the embodiments of the present disclosure.

The term used in the embodiments of the present disclosure is for the purpose of describing particular examples only and is not intended to limit the embodiments of the present disclosure. As used in the present disclosure, the singular forms “a”, “an” and “the” are intended to include the plural forms as well, unless the context clearly indicates otherwise. It should also be understood that the term “and/or” as used herein refers to and includes any and all possible combinations of one or more of the associated listed items.

It shall be understood that, although the terms “first,” “second,” “third,” and the like can be used herein to describe various information, the information should not be limited by these terms. These terms are only used to distinguish the same type of information from each other. For example, without departing from the scope of the present disclosure, first information may be referred as second information; and similarly, second information may also be referred as first information.

Depending on the context, the word “if” as used herein can be interpreted as “at the time of”, “when” or “in response to determining”.

As shown in FIG. 1, the embodiments of the present disclosure provide an information processing method, where the method is performed by a first network device and includes the step S1110.

In step S1110, a deleting notification for a PIN is transmitted to a second network device, where the deleting notification is configured to notify a deletion of the PIN. For example, in the step S1110, when the PIN needs to be deleted, a deleting notification for the PIN is transmitted to the second network device, where the deleting notification is configured to notify the deletion of the PIN.

The first network device can be any core network device. The core network device includes but is not limited to a PIN Management Function (PMF) or Unified Data Management (UDM).

In some embodiments, the first network device will determine whether a PIN needs to be deleted, and in response to determining that the PIN needs to be deleted, transmit a deleting notification for the PIN to the second network device.

The second network device is a network device capable of connecting to the PIN. For example, the second network device may also be a core network device. For example, the second network device may be a device for accessing the PIN and mobility management.

For example, the second network device includes but is not limited to an Access Management Function (AMF).

For example, the deleting notification may at least include an identification (ID) of the PIN, where the ID can be used to indicate the PIN to be deleted. As another example, the deleting notification may also include a deleting indication, which is configured to indicate that a current notification is a deleting notification.

For example, the deleting notification can be a notification message with a pre-set format, such that other network devices and/or PINs can know that the current notification is a deleting notification based on the format of the message after receiving the deleting notification. Therefore, there is no need to include a specific deleting indication in the deleting notification.

The forwarding of the deleting notification to the PIN may include transmitting the deleting notification to each Personal Internet of Things Element (PINE) within the PIN. For example, if a PINE deletes the information of a PIN locally, the PINE will not access the network again through the PIN, or by disconnecting from the PIN, the PINE will no longer access the network through the PIN.

The network accessed by the PIN may include but is not limited to a 3GPP network.

If each PINE within the PIN receives a deleting notification and knows that the PIN has been deleted, the PINE can stop using the PIN to connect to the network.

In short, the first network device can achieve timely deletion of PINs and control of PINs by transmitting deleting notifications. In some embodiments, the transmitting of a deleting notification for a PIN to the second network device includes: in response to meeting a preset condition, transmitting the deleting notification for the PIN to the second network device.

The preset condition includes at least one of the following:
expiration of a validity timer of the PIN; detection of an illegal device connected to the PIN; detection of a non-payment event for the PIN; or invalidity of subscription information of the PIN.

The deletion of PIN requires meeting the preset condition, and when the preset condition is met, it is determined to delete the PIN. If it is determined to delete the PIN, a notification will be transmitted to the second network device to delete the PIN.

As shown in FIG. 2, the embodiments of the present disclosure provide an information processing method, where the method is performed by a first network device and includes the steps S1210 to S1220.

In step S1210, it is determined whether the PIN needs to be deleted.

In step S1220, in response to determining that the PIN needs to be deleted, a deleting notification for the PIN is transmitted to the second network device. For example, based on the subscription information of the PIN and/or the triggering event of deletion, whether the PIN needs to be deleted is determined. In some embodiments, determining whether the PIN needs to be deleted may include at least one of the following:
if the validity timer for the PIN expires, determining that the PIN needs to be deleted;
if an illegal device connected to the PIN is detected, determining that the PIN needs to be deleted; or
if a deletion event for the PIN is detected, determining that the PIN needs to be deleted.

For example, if the PIN is configured with a validity timer, it is determined that the PIN needs to be deleted upon expiration of the validity timer. For example, a temporary PIN may be set up at an accident site and/or a repair site, and a validity timer is set when the temporary PIN is set up.

In other embodiments, the PIN may also be configured with an invalidity timer, and after the invalidity timer starts and expires, the PIN may be considered to need to be deleted.

For example, if it is detected that a PIN is connected to an illegal device, where the illegal device may spread viruses and introduce network attacks, and the PIN can be temporarily deleted to protect network security. As another example, the illegal device may include: a device that has not obtained a legal certificate issued by a network operator or a third-party certification agency.

The above are just examples of illegal devices. In short, the illegal device can be any device that cannot be recognized and/or is detected as a threat by the network.

In other cases, deletion event(s) can also be configured. The event(s) can be recorded in the first network device as event information. If the current time and/or the current operating status of the PIN triggers the deletion event, it is determined to delete the PIN.

For example, the deletion event includes at least one of the following:
a non-payment event of PIN; or an invalidity of subscription information of the PIN.

There can be various types of non-payment events for the PIN, and can be specifically any one of the following:
when the PIN changes from a non-owed state to a non-payment state, it is determined that the deletion event is triggered; or if an arrears value of the PIN reaches a preset range, it is determined that the deletion event is triggered.

The invalidity of the subscription information may include: if a force majeure event that causes the subscription corresponding to the subscription information to become invalid occurs, it is determined that the subscription information is invalid; and/or if there is an agreement that causes the subscription information to no longer be executed, it is determined that the subscription information is invalid.

In summary, if the validity timer of the PIN expires, an illegal device is connected to the PIN, and/or a deletion event is triggered, it can be considered that the PIN needs to be deleted.

In some embodiments, the deleting notification may at least include the identification of the PIN. In some embodiments, the deleting notification includes at least one of the following: the ID of the PIN Element with Management Capability (PEMC) used for forwarding the deleting notification; the ID of the PIN; or the ID of the PIN Element with Gateway Capability (PEGC) used for forwarding the deleting notification.

For example, the ID of the PEMC carried in the deleting notification is configured to indicate the PEMC to forward the deleting notification to the PINE of the PIN; and/or, the ID of the PEGC carried in the deleting notification is configured to indicate the PEGC to forward the deleting notification to the PINE of the PIN.

The deleting notification is forwarded to the PINE of the PIN through the PEMC or is forwarded to the PINE of the PIN through the PEGC.

For example, if the deleting notification includes the ID of the PEMC, the deleting notification is transmitted to the PIN through the PEMC corresponding to the ID of the PEMC carried in the deleting notification.

If the deleting notification includes the ID of the PEGC, the deleting notification is transmitted to the PIN through the PEGC corresponding to the ID of the PEGC carried in the deleting notification.

As shown in FIG. 3, the embodiments of the present disclosure provide an information processing method, where the method is performed by a first network device and includes the steps S1310 to S1320.

In step S1310, a deleting notification for a PIN is transmitted to a second network device, where the deleting notification is configured to notify a deletion of the PIN. In step S1320, acknowledgement information is received, where the acknowledgement information is configured to indicate that the deletion for the PIN is completed.

In the embodiments of the present disclosure, the first network device will transmit a deleting notification when the PIN needs to be deleted, and if the PIN is deleted, a acknowledgement information will be received. In the embodiments of the present disclosure, after receiving the acknowledgement information, the first network device will determine that the PIN has been deleted.

In other embodiments, the first network device may further start a deletion timer after transmitting the deleting notification. If no deletion objection information is received before the deletion timer expires, it can be considered that the PIN has been deleted.

As shown in FIG. 4, the embodiments of the present disclosure provide an information processing method. The method is performed by a first network device, where the first network device is a PIN Management Function (PMF), the PMF stores information of an Access Management Function (AMF) corresponding to a PIN Element (PINE) of the PIN; and the method includes step S1420.

In step S1420, the PMF, according to the information of the AMF corresponding to the PINE, transmits the deleting notification for the PIN to the AMF corresponding to the PIN.

If the first network device is a PMF, the PMF can determine whether information of the AMF of the PINE of the to-be-deleted PIN is stored locally. If so, it indicates that the PMF can know, based on stored information, which AMF to transmit the deleting notification to.

For example, the information of the AMF includes but is not limited to: the Internet Protocol (IP) address of the AMF, and/or the identification (ID) of the AMF, and/or the link information that can reach the AMF.

As shown in FIG. 5, the embodiments of the present disclosure provide an information processing method. The method is performed by a first network device, where the first network device is a PIN Management Function (PMF), the PMF stores information of an Access Management Function (AMF) corresponding to a PIN Element (PINE) of the PIN; and the method includes steps S1510 to S1540.

In step S1510, the first network device is a PMF, and it is determined whether the PMF stores information about the AMF corresponding to the PIN. In step S1520, the PMF transmits a query request to the Unified Data Management (UDM). In step S1530, a query response is received, where the query response includes information of the AMF corresponding to the PIN. In step S1540, according to the information of the AMF in the query response, the deleting notification for the PIN is transmitted to the AMF corresponding to the PIN.

In the embodiments of the present disclosure, if the information of the AMF is not stored locally in the PMF, it can be queried in the UDM, and after querying the information of the AMF, a deleting notification of the PIN can be transmitted to the corresponding AMF.

As shown in FIG. 6, the embodiments of the present disclosure provide an information processing method, where the method is performed by a first network device and includes the steps S1610 to S1630.

In step S1610, where the first network device is a Unified Data Management (UDM), subscription data of the PIN is queried.

In step S1620, based on the subscription data, information of an Access Management Function (AMF) corresponding to the PIN is determined.

In step S1630, the PIN needs to be deleted, and the deleting notification of the PIN is transmitted to the AMF corresponding to the PIN based on the information of the AMF corresponding to the PIN.

The UDM will store the subscription data of the PIN. The subscription data will include the information of the AMF corresponding to the PIN. Before transmitting a deleting notification, the UDM can determine the address and/or ID of the AMF based on the subscription data of the PIN, and then transmit the deleting notification to the corresponding AMF.

As shown in FIG. 7, the embodiments of the present disclosure provide an information processing method, where the method is performed by a second network device and includes the steps S2110 to S2120.

In step S2110, a deleting notification for a Personal Internet of Things Network (PIN) transmitted by a first network device is received.

In step S2120, the deleting notification is transmitted to PEMC or PEGC, where the deleting notification is configured to notify the deletion of the PIN. The second network device can be an AMF for the PIN. For example, after receiving the deleting notification transmitted by the first network device, the second network device will transmit the deleting notification to PEMC or PEGC, such that the deleting notification will ultimately be forwarded to the PIN through PEMC or PEGC, to inform PINE of the deletion.

The deleting notification may at least include the identification of the PIN, such that the second network device determines the PEMC and/or PEGC of the PIN based on the PIN information contained in the deleting notification, and then transmits the deleting notification to the corresponding PEMC and/or PEGC, etc.

In some embodiments, the deleting notification includes: the identification of the PEMC and/or the identification of the PEGC. If the deleting notification includes the identification of the PEMC and/or the identification of the PEGC, then the second network device does not need to query the deleting notification locally or query the deleting notification in a database such as UDM.

In some embodiments, the method further includes: receiving acknowledgement information, where the acknowledgement information indicates that the deletion for the PIN is completed. After the acknowledgement information is received, the acknowledgement information is returned to the first network device. In some embodiments, the step S2120 may include:

transmitting the deleting notification to the base station, where the deleting notification is forwarded or transparently transmitted to PEMC or PEGC via the base station.

After receiving the deleting notification, PEMC or PEGC will forward the deleting notification to the PINE of the PIN. After receiving the deleting notification for the PIN, PINE will delete the corresponding PIN.

As shown in FIG. 8, the embodiments of the present disclosure provide an information processing method, where the method is performed by PEMC or PEGC, and the method includes steps S3110 to S3120.

In step S3110, a deleting notification for a PIN transmitted by a second network device is received. In step S3120, the deleting notification is transmitted to the PINE of the PIN, where the deleting notification is configured to notify the deletion of the PIN. This information processing method is performed by PEMC and/or PEGC.

PEMC or PEGC will receive the deleting notification from the second network device such as the AMF, and after receiving the deleting notification, will provide the deleting information to the corresponding PIN.

For example, a PEMC may manage one or more PINs, and similarly, a PEGC can also be configured for one or more PINs to connect a 3Gpp network.

For example, the step S3110 may include: receiving a deleting notification of the PIN forwarded or transparently transmitted by the second network device. As shown in FIG. 9, an information processing method is provided, performed by a PIN Element with Management Capability (PEMC) or a PIN Element with Gateway Capability (PEGC), and includes steps S3210 to S3230.

In step S3210, a deleting notification for a PIN transmitted by a second network device is received. In step S3220, the deleting notification is transmitted to the PINE of the PIN, where the deleting notification is configured to notify the deletion of the PIN. In step S3230, information of the PIN stored locally in the PEMC is deleted.

The PEGC and/or PEMC can directly delete the information of the PIN after transmitting the deleting notification, or can wait until the PINE device of the PIN reports that the deletion has been completed before deleting the information of the PIN stored locally by the PEGC and/or PEMC.

In some embodiments, the method further includes: transmitting acknowledgement information to the second network device.

For example, if it is determined that the PEMC and/or PEGC will perform a deletion operation after receiving the deleting notification, the PEMC and/or PEGC can return the acknowledgement information to the second network device when transmitting the deleting notification to the PIN or before transmitting the deleting notification to the PIN.

For example, after receiving the deleting notification, the PEMC and/or PEGC may, after receiving acknowledgement information indicating that the deletion is completed returned by all PINEs in the to-be-deleted PIN, transmit the acknowledgement information to the second network device.

In some embodiments, the PEMC and/or the PEGC may default to not transmitting acknowledgement information to the second network device if a deletion operation for a PIN is performed, and if the second network device does not receive the acknowledgement information within a certain period of time, it will be determined that the deleting notification has been successfully transmitted and the deletion for the PIN has been completed.

For example, the method includes:
receiving acknowledgement information that is returned, based on the deleting notification, by the PINE of the PIN.

This step can be an optional step, and if it is executed by the PINE, the PEGC and/or PEMC will receive the acknowledgement information. In the case where PINE returns acknowledgement information, the PEGC and/or PEMC may return acknowledgement information to the second network device after receiving the acknowledgement information returned by PINE.

If the user interface (UI) of the PEGC and/or PEMC receives a user operation that raises an objection to the deletion, the PEGC and/or PEMC will temporarily suspend transmitting the deleting notification to the PIN and return the objection information to the second network device, thereby reducing the possibility of accidental deletion of the PIN.

As shown in FIG. 10, the embodiments of the present disclosure provide an information processing method, where the method is performed by PINE, and the method includes step S4110.

In step S4110, a deleting notification transmitted by a PIN Element with Management Capability (PEMC) or a PIN Element with Gateway Capability (PEGC) is received; where the deleting notification is configured to notify deletion of the PIN.

The PINE here can refer to any device, such as smart home appliances, smart office devices, in car devices, and/or wearable devices.

In the embodiments of the present disclosure, after receiving the deleting notification, the PINE will know that the PIN connected to itself will be deleted.

The PINE can delete the information of the PIN locally or invalidate the information of the PIN indicated by the deleting notification, thereby deleting the PIN for the PINE.

In some embodiments, the PINE may default to deleting the PIN upon receiving the deleting notification, without returning acknowledgement information to PEGC and/or PEMC.

In some embodiments, the method further includes: transmitting, according to the deleting notification, acknowledgement information to the PEGC.

If the PINE intends to return acknowledgement information to PEGC or PEMC, the PINE deletes the information of the PIN after receiving the deleting notification and transmitting the acknowledgement information to PEGC or PEMC.

For example, the information of the PIN may include identification such as the user account used for the PIN. If the PIN is set with a connection password, the information of the PIN may further include the connection password.

For example, the information of the PIN may further include the connection manner information of the PIN, such as connection through webpage login, or connection through mobile phone number SMS verification code, etc.

Of course, the above are only examples of the information of the PIN, and the specific implementation is not limited to the above examples.

As shown in FIG. 11, the embodiments of the present disclosure provide an information processing method, which may include steps 0 to 6.

In step 0, PMF detects the trigger of deletion for a PIN. For example, if the validity timer of the PIN expires, UDM/PMF determines to delete the PIN.

In step 1, PMF transmits a deleting notification for the PIN to AMF, where the deleting notification includes the ID of the PIN. The deleting notification further includes: the ID of the PEMC and/or the ID of the PEGC.

If the PMF locally stores the information of the AMF that serves the PIN and the ID of PEMC and/or the ID of PEGC, the PMF can directly transmit the deleting notification to the AMF that serves the PIN.

In step 2, AMF transmits the deleting notification for the PIN to PEMC or PEGC via gNB.

In step 3, PEMC(s) or PEGC(s) transmits a deleting notification for the PIN to PINE.

In step 4, PINE(s) transmits acknowledgement (ACK) information for the deletion of the PIN to PEMC or PEGC. This step is optional, i.e., it can be executed or not executed in some scenarios.

In step 5, PEMC(s) or PEGC(s) deletes all information of the PIN. This step can be executed after completing step 2.

In step 6, PEMC(s) transmits ACK for the deletion of the PIN to PMF/UDM via gNB and AMF. For example, this step can also be an optional step.

As shown in FIG. 12, the embodiments of the present disclosure provide an information processing method, which may include steps 0 to 6.

In step 0, UDM detects the trigger of deletion for a PIN. For example, if the validity timer of the PIN expires, UDM/PMF determines to delete the PIN. UDM/PMF determines the AMF(s) that serves the PEMC or PMEG for the PIN.

In step 1, UDM transmits a deleting notification for the PIN to AMF, where the deleting notification includes the ID of the PIN. The deleting notification further includes: the ID of the PEMC and/or the ID of the PEGC.

In step 2, AMF transmits the deleting notification for the PIN to PEMC or PEGC via gNB.

In step 3, PEMC(s) or PEGC(s) transmits a deleting notification for the PIN to PINE.

In step 4, PINE(s) transmits acknowledgement (ACK) information for the deletion of the PIN to PEMC or PEGC. This step is optional, i.e., it can be executed or not executed in some scenarios.

In step 5, PEMC(s) or PEGC(s) deletes all information of the PIN. This step can be executed after completing step 2.

In step 6, PEMC(s) transmits ACK for the deletion of the PIN to PMF/UDM via gNB and AMF. For example, this step can also be an optional step.

As shown in FIG. 13, the embodiments of the present disclosure provide an information processing method, which may include steps 0 to 6.

In step 0, PMF detects the trigger of deletion for a PIN. For example, if the validity timer of the PIN expires, UDM/PMF determines to delete the PIN.

In step 0a, PMF requests subscription data from UDM.

In step 0b, UDM returns the subscription data to PMF; where the subscription data can be configured to determine the AMF that serves the PIN and the ID of the PEMC and/or the ID of the PEGC.

In step 1, UDM transmits a deleting notification for the PIN to AMF, where the deleting notification includes the ID of the PIN. The deleting notification further includes: the ID of the PEMC and/or the ID of the PEGC.

In step 2, AMF transmits the deleting notification for the PIN to PEMC or PEGC via gNB.

In step 3, PEMC(s) or PEGC(s) transmits a deleting notification for the PIN to PINE.

In step 4, PINE(s) transmits acknowledgement (ACK) information for the deletion of the PIN to PEMC or PEGC. This step is optional, i.e., it can be executed or not executed in some scenarios.

In step 5, PEMC(s) or PEGC(s) deletes all information of the PIN. This step can be executed after completing step 2.

In step 6, PEMC(s) transmits ACK for the deletion of the PIN to PMF/UDM via gNB and AMF. For example, this step can also be an optional step.

As shown in FIG. 14, the embodiments of the present disclosure provide an information processing apparatus, where the apparatus includes a first transmitting module 110.

The first transmitting module 110 is configured to transmit a deleting notification for a Personal Internet of Things Network (PIN) to a second network device, where the deleting notification is configured to notify deletion of the PIN.

The information processing apparatus may be a first network device.

In some embodiments, the first transmitting module 110 may be a program module. After being executed by the processor, the program module can achieve the above operations.

In other embodiments, the first transmitting module 110 may be a software hardware combination module. The software hardware combination module includes but is not limited to programmable arrays. The programmable array includes but is not limited to: on-site programmable array and/or complex programmable array.

In some embodiments, the first transmitting module 110 may be a pure hardware module; The pure hardware module includes but is not limited to a dedicated integrated circuit.

In some embodiments, the first transmitting module 110 may be configured to transmit a deleting notification for the PIN to the second network device in response to meeting a preset condition.

Where the preset condition includes at least one of the following:
expiration of a validity timer of the PIN; detection of an illegal device connected to the PIN; detection of a non-payment event for the PIN; or invalidity of subscription information of the PIN.

In some embodiments, the deleting notification includes at least one of the following: the ID of the PIN Element with Management Capability (PEMC) used for forwarding the deleting notification; the ID of the PIN; or an ID of a PIN Element with Gateway Capability (PEGC) configured to forward the deleting notification. In some embodiments, the apparatus further includes a first receiving module.

The first receiving module is configured to receive acknowledgement information, where the acknowledgement information is configured to indicate that the PIN deletion is completed. In some embodiments, the first network device is a PIN Management Function (PMF), the PMF stores information of an Access Management Function (AMF) corresponding to a PIN Element (PINE) of the PIN.

The first transmitting module 110 is configured to, according to the information of the AMF corresponding to the PINE, transmit the deleting notification for the PIN to the AMF corresponding to the PIN.

For example, the apparatus further includes: The second determining module is configured to, where the first network device is a PIN Management Function (PMF), determine whether the PMF stores information of an Access Management Function (AMF) corresponding to a PIN Element (PINE) of the PIN.

The first transmitting module 110 is configured to, where the PIN needs to be deleted and the PMF stores the corresponding AMF for the PIN, according to the information of the AMF corresponding to the PINE, transmit the deleting notification for the PIN to the AMF corresponding to the PIN.

In some embodiments, the first network device is a PIN Management Function (PMF), the PMF stores information of an Access Management Function (AMF) corresponding to a PIN Element (PINE) of the PIN. The apparatus further includes a second transmitting module. The second transmitting module is configured to transmit, by the PMF, a query request to a Unified Data Management (UDM).

The second receiving module is configured to receive a query response, where the query response includes information of the AMF corresponding to the PIN.

The first transmitting module 110 is configured to, according to the information of the AMF, transmit the deleting notification for the PIN to the AMF corresponding to the PIN.

In some embodiments, the apparatus further includes a querying module. The query module configured to, where the first network device is a Unified Data Management (UDM), query subscription data of the PIN. The third determination module is configured to determine, based on the subscription data, information of an Access Management Function (AMF) corresponding to the PIN.

The first transmitting module 110 is configured to, according to the information of the AMF corresponding to the PIN, transmit the deleting notification for the PIN to the AMF corresponding to the PIN.

As shown in FIG. 15, the embodiments of the present disclosure provide an information processing apparatus, where the apparatus includes a first transmitting module 110. The third receiving module 210 is configured to receive a deleting notification for a Personal Internet of Things Network (PIN) transmitted by a first network device.

The third transmitting module 220 is configured to transmit the deleting notification to a PIN Element with Management Capability (PEMC) or a PIN Element with Gateway Capability (PEGC), where the deleting notification is configured to notify deletion of the PIN.

The information processing apparatus provided in the embodiments of the present disclosure may be included in a second network device, which may be, but is not limited to: AMF.

In some embodiments, the third receiving module 210 and the third transmitting module 220 may be program modules. After being executed by the processor, the program modules can achieve the above operations.

In other embodiments, the third receiving module 210 and the third transmitting module 220 may be software hardware combination modules. The software hardware combination modules include but are not limited to programmable arrays. The programmable array includes but is not limited to: on-site programmable array and/or complex programmable array.

In some embodiments, the third receiving module 210 and the third transmitting module 220 may be pure hardware modules. The pure hardware modules include but are not limited to dedicated integrated circuits.

In some embodiments, the deleting notification includes: the identification of the PEMC and/or the identification of the PEGC. In some embodiments, The third transmitting module 220 is configured to forward or transparently transmit the deletion notification for the PIN to the PEGC or PEMC via the base station.

As shown in FIG. 16, the embodiments of the present disclosure provide an information processing apparatus, where the apparatus includes a fourth transmitting module 310.

The fourth receiving module 310 is configured to receive a deleting notification for a Personal Internet of Things Network (PIN) transmitted by a second network device; and a fourth transmitting module 320 is configured to transmit the deleting notification to a PIN Element (PINE) of the PIN, where the deleting notification is configured to notify deletion of the PIN.

The information processing apparatus can be PEMC and/or PEGC, etc.

In some embodiments, the fourth receiving module 310 and the fourth transmitting module 320 may be program modules. After being executed by the processor, the program modules can achieve the above operations.

In other embodiments, the fourth receiving module 310 and the fourth transmitting module 320 may be software hardware combination modules. The software hardware combination modules include but are not limited to programmable arrays. The programmable array includes but is not limited to: on-site programmable array and/or complex programmable array.

In some embodiments, the fourth receiving module 310 and the fourth transmitting module 320 may be pure hardware modules. The pure hardware modules include but are not limited to dedicated integrated circuits.

In some embodiments, the apparatus further includes a deleting module.

The deleting module is configured to delete information of the PIN stored locally in the PEMC. In some embodiments, the fourth transmitting module 320 is further configured to transmit acknowledgement information to the second network device. In some embodiments, the fourth receiving module 310 is further configured to receive the acknowledgement information returned by the PINE of the PIN based on the deleting notification.

As shown in FIG. 17, the embodiments of the present disclosure provide an information processing apparatus, where the apparatus includes a fifth transmitting module 410.

The fifth receiving module 410, configured to receive a deleting notification transmitted by a PIN Element with Management Capability (PEMC) or a PIN Element with Gateway Capability (PEGC); where the deleting notification is configured to notify deletion of the PIN.

The information processing apparatus can be included in PINE.

In some embodiments, the fifth receiving module 410 may include a program module. After being executed by the processor, the program module can achieve the above operations.

In other embodiments, the fifth receiving module 410 may be a software hardware combination module. The software hardware combination module includes but is not limited to programmable arrays. The programmable array includes but is not limited to: on-site programmable array and/or complex programmable array.

In some embodiments, the fifth receiving module 410 may be a pure hardware module; The pure hardware module includes but is not limited to a dedicated integrated circuit.

In some embodiments, the apparatus further includes a fifth transmitting module. The fifth transmitting module is configured to transmit, according to the deleting notification, acknowledgement information to the PEGC or the PEMC.

The embodiments of the present disclosure provide a communication system including a first network device, a second network device, a third network device, and a PIN Element (PINE).

The first network device is configured to transmit a deleting notification for a Personal Internet of Things Network (PIN) to the second network device, where the deleting notification is configured to request deletion of the PIN.

The second network device is configured to receive the deleting notification for the PIN transmitted by the first network device and transmit the deleting notification to the PINE through the third network device; where the third network device is a PIN Element with Management Capability (PEMC) or a PIN Element with Gateway Capability (PEGC).

In some embodiments, the first network device is a PIN Management Function (PMF), or the first network device is a Unified Data Management (UDM).

In some embodiments, the second network device is an AMF.

The PIN includes PEMC, PEGC, and PINE. The deleting notification is forwarded to the PINE through PEMC and/or PEGC after passing through the first network device, the second network device, and the base station.

After receiving the deleting notification, PINE will locally delete the information of the PIN to achieve the deletion of the PIN. In some embodiments, the PINE may further return a acknowledgement information. The acknowledgement information is passed through PEMC and/or PEGC to reach the base station. Then the acknowledgement information is transparently transmitted or forwarded by the base station to the AMF of PINE, and forwarded to the PMF or UDM via the AMF.

The embodiments of the present disclosure provide a communication device including:
one or more memories storing instructions executable by one or more processors; the one or more processors connected to the one or more memories.

The one or more processors are configured to execute the information processing method provided by any one of the aforementioned technical solutions. The processor may include various types of storage media, which are non-transitory computer storage media that can continue to retain information stored thereon after the communication device loses power.

The communication device includes: a first network device, a second network device, PEGC, PEMC, and/or PINE. The processor may be connected to the memory via a bus or the like, and may be used to read an executable program stored in the memory, e.g., at least one of the methods shown in FIGS. 2 to 13.

FIG. 18 is a schematic structural diagram of a communication device 800 according to an embodiment of the present disclosure. For example, the communication device 800 can be a mobile phone, a computer, a digital broadcast terminal, a message transmitting and receiving device, a gaming console, a tablet device, a medical device, a fitness device, a personal digital assistant, and the like. The communication device 800 can be PEMC, PEGC, or PINE.

Referring to FIG. 18, the communication device 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operation of the communication device 800, such as operations associated with displays, phone calls, data communications, camera operations, and recording operations. The processing assembly 802 may include one or more processors 820 to execute instructions to complete all or a part of the blocks of the above methods. Further, the processing component 802 may include one or more modules to facilitate interaction between the processing component 802 and another component. For example, the processing component 802 may include a multimedia module to facilitate the interaction between the multimedia component 808 and the processing component 802.

The memory 804 is configured to store different types of data to support operations at the communication device 800. Examples of such data include instructions of any application program or method operable on the communication device 800, contact data, telephone directory data, messages, pictures, videos, and the like. The memory 804 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or a CD.

The power source assembly 806 provides power to different assemblies of the communication device 800. The power source assembly 806 may include a power source management system, one or more power sources and other assemblies associated with generating, managing and distributing power for the communication device 800.

The multimedia component 808 may include a screen for providing an output interface between the communication device 800 and a user. In some examples, the screen may include a Liquid Crystal Display (LCD) and a Touch Panel (TP). If the screen includes a touch panel, the screen may be implemented as a touch screen for receiving an input signal from a user.

The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 808 may include a front camera and/or a rear camera.

When the communication device 800 is in an operation mode, such as a shooting mode or a video mode, the front camera and/or the rear camera may receive external multimedia data. Each of the front camera and the rear camera may be a fixed optical lens system or be of a focal length and a capability of an optical zoom.

The audio component 810 is configured to output and/or input an audio signal. For example, the audio component 810 includes a microphone (MIC).

When the communication device 800 is in an operation mode, such as a call mode, a record mode and a voice recognition mode, the microphone is configured to receive an external audio signal.

The received audio signal can be further stored in memory 804 or transmitted via communication component 816. In some examples, the audio component 810 also includes a loudspeaker for outputting an audio signal.

The I/O interface 812 provides an interface between the processing component 802 and a peripheral interface module. The above peripheral interface module may be a keyboard, a click wheel, a button, or the like. These buttons may include but not limited to, a home button, a volume button, a start button and a lock button.

The sensor component 814 may include one or more sensors for providing state assessments in different aspects for the communication device 800. For example, the sensor component 814 may detect the on/off state of the communication device 800, and relative locations of components, such as a display and a small keyboard of the communication device 800. The sensor component 814 may also detect a position change of the communication device 800 or a component of the communication device 800, the presence or absence of contact of a user with the communication device 800, an orientation or acceleration/deceleration of the communication device 800 and a temperature change of the communication device 800.

The sensor component 814 may include a proximity sensor for detecting the existence of a nearby object without any physical touch. The sensor component 814 may also include an optical sensor, such as a CMOS or CCD image sensor used in an imaging application. In some embodiments, the sensor component 814 may also include an acceleration sensor, a gyro sensor, a magnetic sensor, a pressure sensor, or a temperature sensor.

The communication component 816 is configured to facilitate wired or wireless communication between the communication device 800 and other devices. The communication device 800 may access a wireless network based on a communication standard, such as WIFI, 2G or 3G, or a combination thereof. In some embodiments, the communication component 816 may receive a broadcast signal or broadcast-related information from an external broadcast management system via a broadcast channel. In an example, the communication component 816 may also include a Near Field Communication (NFC) module to facilitate short-range communications. For example, the NFC module may be implemented according to a Radio Frequency Identification (RFID) technology, an Infrared Data Association (IrDA) technology, an Ultra Wideband (UWB) technology, a Bluetooth® (BT) technology and other technologies.

In some embodiments, the communication device 800 may be implemented by one or more of an application-specific integrated circuit (ASIC), a digital signal processor (DSP), a digital signal processing device (DSPD), programmable logical device (PLD), field programmable gate array (FPGA), a controller, microcontroller, a microprocessor or other electronic components to execute the above methods.

In an example, a non-transitory machine readable storage medium storing machine executable instructions is provided, such as the memory 804 storing instructions. The instructions may cause the processor 820 in the communication device 800 to perform the above method. For example, the non-transitory computer readable storage medium may be a Read-Only Memory (ROM), a Random Access Memory (RAM), a CD-ROM, a magnetic tape, a floppy disk and an optical data storage device, etc.

As shown in FIG. 19, an embodiment of the present disclosure illustrates a network device. For example, the network device 900 may be provided as a network side device. The network device 900 may be the aforementioned first network device and/or second network device.

Referring to FIG. 19, the network device 900 includes a processing component 922, which further includes one or more processors, and a memory resource represented by a memory 932 for storing instructions, such as applications, that can be executed by the processing component 922. The application stored in the memory 932 may include one or more modules and each module corresponds to a set of instructions. In addition, the processing component 922 is configured to execute instructions to perform any of the above methods applied to the access device, for example, as the method shown in any one of FIGS. 4 to 9.

The network device 900 may also include a power supply component 926 configured to perform power management of the network device 900, a wired or wireless network interface 950 configured to connect the network device 900 to the network, and an input-output (I/O) interface 958. The network device 900 can operate an operating system stored in the memory 932, such as Windows Server™, Mac OS X™, Unix™, Linux™, FreeBSD™ or the like.

The embodiments of the present disclosure provide a computer storage medium that stores executable programs. After being executed by the processor, the executable program can implement the information processing method according to any one of the aforementioned technical solutions, such as the information processing method according to any one of FIGS. 1 to 13.

The computer storage media may include any non-transitory storage media.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the art that are not disclosed in the present disclosure. The specification and embodiments herein are intended to be illustrative only and the real scope and spirit of the present disclosure are indicated by the claims of the present disclosure.

It is to be understood that the present disclosure is not limited to the precise structures described above and shown in the accompanying drawings and can be modified or changed without departing from the scope of the present disclosure. The scope of protection of the present disclosure is limited only by the appended claims.

1. An information processing method, performed by a first network device, comprising:
transmitting a deleting notification for a Personal Internet of Things Network (PIN) to a second network device, wherein the deleting notification is configured to notify deletion of the PIN.

2. The method according to claim 1, wherein transmitting the deleting notification for the PIN to the second network device comprises:
transmitting, in response to meeting a preset condition, the deleting notification for the PIN to the second network device;
wherein the preset condition comprises at least one of:
expiration of a validity timer of the PIN;
detection of an illegal device connected to the PIN;
detection of a non-payment event for the PIN; or invalidity of subscription information of the PIN.

3. The method according to claim 1, wherein the deleting notification comprises at least one of:
an identification (ID) of a PIN Element with Management Capability (PEMC) configured to forward the deleting notification;
an ID of the PIN; or
an ID of a PIN Element with Gateway Capability (PEGC) configured to forward the deleting notification.

4. The method according to claim 1, further comprising:
receiving acknowledgement information, wherein the acknowledgement information is configured to indicate that the deletion for the PIN is completed.

5. The method according to claim 1, wherein the first network device is a PIN Management Function (PMF), the PMF stores information of an Access Management Function (AMF) corresponding to a PIN Element (PINE) of the PIN; and
transmitting the deleting notification for the PIN to the second network device comprises:
according to the information of the AMF corresponding to the PINE, transmitting the deleting notification for the PIN to the AMF corresponding to the PIN.

6. The method according to claim 1, wherein the first network device is a PIN Management Function (PMF), the PMF stores information of an Access Management Function (AMF) corresponding to a PIN Element (PINE) of the PIN; and the method further comprises:
transmitting, by the PMF, a query request to a Unified Data Management (UDM); and
receiving a query response, wherein the query response comprises information of the AMF corresponding to the PIN; and
transmitting the deleting notification for the PIN to the second network device comprises:
according to the information of the AMF, transmitting the deleting notification for the PIN to the AMF corresponding to the PIN.

7. The method according claim 1,
wherein the first network device is Unified Data Management (UDM), and the method further comprises:
querying subscription data of the PIN; and
determining, based on the subscription data, information of an Access Management Function (AMF) corresponding to the PIN; and
transmitting the deleting notification for the PIN to the second network device comprises:
transmitting, according to the information of the AMF corresponding to the PIN, the deleting notification for the PIN to the AMF corresponding to the PIN.

8. An information processing method, performed by a second network device, comprising:
receiving a deleting notification for a Personal Internet of Things Network (PIN) transmitted by a first network device; and
transmitting the deleting notification to a PIN Element with Management Capability (PEMC) or a PIN Element with Gateway Capability (PEGC), wherein the deleting notification is configured to notify deletion of the PIN.

9. The method according to claim 8, wherein the deleting notification comprises: an identification (ID) of the PEMC or an identification (ID) of the PEGC.

10. The method according to claim 8, wherein transmitting the deleting notification to the PEMC or the PEGC comprises:
transmitting, via a base station, the deleting notification to the PEMC or the PEGC.

11. An information processing method, performed by a PIN Element with Management Capability (PEMC) or a PIN Element with Gateway Capability (PEGC), comprising:
receiving a deleting notification for a Personal Internet of Things Network (PIN) transmitted by a second network device; and
transmitting the deleting notification to a PIN Element (PINE) of the PIN, wherein the deleting notification is configured to notify deletion of the PIN.

12. The method according to claim 11, further comprising:
deleting information of the PIN stored locally in the PEMC.

13. The method according to claim 11, further comprising:
transmitting acknowledgement information to the second network device.

14. The method according to claim 11, comprising:
receiving acknowledgement information that is returned, based on the deleting notification, by the PINE of the PIN.

15-20. (canceled)

21. A communication device, comprising:
a processor;
a transceiver; and
a memory storing a program executable by the processor,
wherein the processor is configured to perform the method according to claim 1.

22. A non-transitory computer storage medium computer storage medium storing an executable program that, when executed by a processor, causes the processor to perform implement the method according to claim 1.

23. (canceled)

24. (canceled)

25. (canceled)

26. A communication device, comprising:
a processor;
a transceiver; and
a memory storing a program executable by the processor,
wherein the processor is configured to perform the method according to claim 8.
